(19) United States
(12) Patent Application Publication
(10) Pub. No.: US 2015/0206367 A1
(43) Pub. Date: Jul. 23, 2015

(54) CONTROL OF OPERATION OF A LOCK

(71) Applicant: KNOCK N'LOCK LTD., Yokneam (IL)

(72) Inventors: Ilan Goldman, Herzliya (IL); Boaz Harel, Tel-Aviv (IL)

(73) Assignee: KNOCK N'LOCK LTD., Yokneam (IL)

(21) Appl. No.: 14/412,023

(22) PCT Filed: Jul. 2, 2013
(86) PCT No.: PCT/IL2013/050561

§ 371 Date: Dec. 30, 2014

Related U.S. Application Data
(60) Provisional application No. 61/667,602, filed on Jul. 3, 2012.
(60) Provisional application No. 61/767,967, filed on Feb. 22, 2013.

(51) Int. Cl. G07C 9/00

(52) U.S. Cl. CPC G07C 9/00182; G07C 2009/00769

(57) ABSTRACT

Provided is an access control system, including one or more locks, each includes a receiver for receiving a first signal and a processor module for decoding the first signal and for controlling operation of the lock; one or more portable access control units for delivering said first signal to one of said receiving modules when in proximity to a respective lock; and a central system controller for delivering to said control unit at least one second signal; said first signal being generated by said portable access control unit based on said second signal.

### TECHNOLOGICAL FIELD

The present invention concerns locks and more specifically code-activated locks with an electronic access control system.

### BACKGROUND

Modern locks for high security installations typically have an electronic control module that controls the lock through a coded input, typically entered by the user keying a code onto a keyboard associated with the lock.

The most secure electronic systems are those operating off-line, namely those which are not directly linked to a central system controller. This presents some challenges as many such locks, particularly in high security installations, are activated by one-time codes, generated as occasional codes that are functional over a defined period of time only. The challenge is manifested in that the controller needs to provide the proper access code, based on some pre-programmed sequence, without the ability to directly communicate with the lock.

The challenges, of course, are magnified where a system comprises a plurality of locks and a plurality of stations that may be scattered over a distance from one another and that need to be accessed by service personnel, technicians, etc., who may need access for a defined time period, without jeopardizing the overall security of the system. This is particularly complex in some cases, for example, where it is sought to ensure that a code used once over a defined time period cannot be re-used for accessing the same lock or other locks.

### DESCRIPTION OF THE INVENTION

The present invention provides a novel system with a plurality of locks and a central system controller (CSC) that controls the operation of locks.

The CSC, as can be appreciated, may be a single server unit, may be a software functionality operating on a computer, may be a functionality that is distributed over several servers operating in a network, etc.

The term “control” when referring to a lock, or “controlling operation of the lock” or any other derivation of these terms, is meant to denote locking or unlocking or imparting any other functionality to a lock. In addition, this term is meant to encompass programming the processor module of the lock in such manner so as to affect future operation of the lock (e.g. automatically unlocking at a specific time and under specific circumstances, programming the lock the processor module in a lock to be primed for unlocking by a defined emergency code, etc.); for example, defining a subsequent first coded signal for opening the lock, (e.g. the first coded signal to which the lock will be responsive to in a subsequent operation).

The system includes an intermediate portable access control unit (PACU) that may be uploaded with access control codes, typically unique’ lock-specific, codes that may then be transmitted to a lock when an operator with the PACU is in the vicinity of a specific lock. The use of the PACU permits an offline control of the locks. For example, the processor module of the lock may be pre-programmed with a plurality of access codes, or such codes may be stored in a memory being part of or associated with the processor module, the details of which are stored in a registry of the CSC. One or more of such codes may then be transmitted from the CSC to the PACU. For high security use, each code may be used one time only and then deleted from, inactivated or marked as used in the CSC. Also, once a certain code is employed by the PACU to control a specific lock or a group of locks, this information may be transmitted back to the CSC to update its respective registry of codes. It is also possible, under some embodiments, particularly in high security applications, to require a combination of two or more codes, e.g. at a defined interval, for control of the lock's operation.

The locks may be entirely online, in which case the PACU is intended for use when the online communication is severed or for the purpose of permitting also a localized control of the lock, e.g. by an operator who needs to access the installation locked by said lock. The locks may also be entirely offline and the entire CSC control of the locks' operation is carried out via the intermediary of the PACU.

The system of the invention may be used for the operation of a plurality of dual-activation locks, i.e. locks having conventional mechanical locking/unlocking means onto which an electromagnetic control module is added. Such dual-activation ensures operability of the lock in situations where one of the activation modes fails to operate.

The system of the invention comprises one or more (typically a plurality of) locks. Each of the locks comprises a processor module that is associated with a signal receiver for receiving a first, typically coded, signal that is decoded by the processor module to thereby control the operation of the lock. The system further comprises one or more PACUs for delivering said first signal to one of said signal receivers when in proximity to a respective lock. The system also comprises a CSC for delivering to said control unit at least one second signal, based on which the PACU generates said first signal, which may be identical or different than the second signal.

The term “signal” is meant to encompass any type of information transmitted between the system's elements, e.g. a code for unlocking or locking a lock. The second signal from the CSC to the PACU may be a wired or wirelessly transmitted electromagnetic signal encoding a lock-control code and the first signal may be an acoustic or mechanical signal encoding a code to be received by the lock's receiver.

A wired communication between the CSC and the PACU may be achieved, for example, by connecting the PACU do a dedicated communication port that is connected to the CSC. The PACU may also, by some embodiments, be connected in a similar manner to the lock for transmission of the first signal. Wired communication may also be achieved through modems. Wireless communication may be a short distance, e.g. via a Bluetooth communication protocol or a long distance through regular RF or cellular communication system.

The PACU may, by one embodiment, be a device or may comprise an accessory configured for delivering a code in the form of an acoustic or mechanical signal. Such a signal may, by an embodiment, be a series of knocks of the kind disclosed in PCT Application No. WO 98/39539 (and its counterpart national patents and patent applications) the contents of which being incorporated herein by reference. In addition, PCT Application No. WO 01/59288 (and its counterpart national patents and patent applications), the content of which being incorporated herein by reference, discloses an accelerometer that can be included as the receiver in a lock, for receiving the series of knocks.

By another embodiment, rather than being delivered through knocks, the first coded signal may be an electromagnetic signal (e.g. radio signal or infra-red signal). By yet another embodiment the first coded signal may be a sound other than knocks (e.g. a series of tones). In general, any signal that can be used to transmit an encoded message from an appropriate user-held unit to a proximal lock may be used in accordance with the invention.

According to an embodiment, the code may be transmitted directly to the lock through near field communication (NFC) functionality of modern mobile communication devices.

The PACU may comprise a decryption or encryption functionally for generating the first signal. The nature of the decryption/encryption functionality may be different in different systems and depends on the level of security and other factors.

The first coded signal delivered by the portable access control unit to the lock may be encrypted, and typically double encrypted. The first encryption may be carried out in the central system controller and the second code transmitted to the portable control unit is thus once encrypted. The control unit itself may be adapted to perform a second encryption through a second encryption algorithm, being similar or different than the first encryption algorithm, and first signal then delivered to the lock is double encrypted. This ensures a high level of security of the code to bar an unauthorized third party from intercepting the signals. Accordingly, the processor module in the lock may comprise a decryption module for decrypting the encrypted or doubly encrypted first signal, to thereby reconstruct the original control signal.

It should be noted that the invention is not limited to the use of double encryption and there may be a single or multiple (3 or more) encryption algorithms operating in the system (e.g. in either one of the central system controller or the portable access control unit), or in some embodiments without any encryption. By an embodiment of the invention, one or both of the first or second signals are encrypted.

The processor module of the lock is pre-programmed for recognition of a first signal with defined attributes and operating the lock based thereon. Such attributes may be, for example, a control code for subsequent opening of the lock, may be a change of operational parameters, change of functions, a new series of access control permissions, and others.

In accordance with an embodiment of the invention, the PACU is an application or a functionality (e.g. an application software) of a mobile communication device, e.g. one that operates through a cellular telephone system. The message may then be delivered from the CSC to this portable control device, through, e.g., the short messaging system (SMS) of the cellular telephone network. Such an SMS is typically encrypted and is then decrypted through a decryption functionality or algorithm operating in the mobile communication device. In order to permit bilateral secured communication between the mobile communication device and the CSC, said device may also comprise an encryption functionality/algorithm operating in it and configured for encryption of an outgoing SMS to be transmitted to the CSC. Thus, the second signal may be delivered to such a mobile communication unit, and from there the first coded signal is delivered to the lock for the purpose of controlling its operation through a variety of means. By one example, the hand-held communication device may be permanently or temporarily linked to a transmission device, e.g. a device adapted to provide a knock-coded signal to the lock or a device adapted to transmit an infra-red or other electronic signal.

The term PACU should be understood to encompass both a dedicated device serving for that purpose or a functionality operating in another device, e.g. an application software in a mobile communication device.

The system may include a number of security enhancing features, one example being a first coded signal that is specific for a defined time window to operate a specific lock. The PACU may be equipped with a location identifying functionality, e.g. one based on a global positioning system (GPS). All mobile communication devices do have GPS functionality and thus a PACU that is an application software of a mobile communication device will inherently have this location functionality. This permits accurate monitoring of the PACU's position and its management based thereon; for example permitting generation of a specific first signal only if and when the PACU is in the vicinity of a specific lock. By another example, a pre-entered first signal may be used only through verification of the position of the control unit. The first coded signal may also, at times, be the same signal for controlling a plurality of locks within a given geographical area (i.e. geo-fencing).

The first coded signal may include other components. For example, other than access control, the first coded signal may be decoded into instructions that define operational parameters of the lock's processor module. The operational parameters may be a control code for subsequent opening of the lock, may be change of operational parameters, change of functions, a new series of access control permissions, and others. In general, through the coded message, any desired instruction to or any desired programming of the processor module may thereby be delivered without the need to connect the lock to an on-line system or without the need to connect any physical devices to the lock for data transmission.

By an example, each first coded signal may be a one-time code, and after its use the lock's processor is rendered receptive to a different first coded signal. Namely, upon receipt of a first coded signal, registries in the lock's processor are activated, rendering the lock operative only to a subsequent different first coded signal. In some embodiments, the central system controller keeps track of first coded signals used for controlling operation of a lock and issuing a subsequent second signal for inducing the portable access control unit to output a defined first coded signal to which a lock is receptive to. Therefore, the system allows for each lock or a group of locks to be operated by a unique first coded signal, which may be used as one-time code only.

By another feature of the invention, the lock may have a dormant, stored emergency code, which may be the same in all locks of a system, e.g. locks of a security installation that needs to be accessed in case of emergency. The emergency code may be activated by receipt of an activation code from the PACU. Thus, the CSC may transmit such an activation code, wirelessly or by any other means, to all relevant PACUs permitting operators in the case of need (e.g. an emergency) to transmit such emergency activation codes to all relevant locks for unlocking or locking the locks.

In cases where the lock is on on-line lock, namely a lock which is operated and controlled via on-line systems, such an emergency code may be used to operate the lock once on-line communication has failed. The emergency code is activated only upon receipt of an activation code from the portable access control unit, avoiding the need to wait for restoration of on-line communication between the lock and the central controller. The activation of an emergency code only by the delivery of an activation code issued by the central controller ensures the controlled management of access control on-line system even in cases where no on-line communication can be established between the central controller and the locks.

The emergency code may be such that operation of a plurality of locks in a given geographical area is afforded. Therefore, such a code may be regarded as an emergency “master code”. The emergency code may be used, for example, in cases in which immediate access to a plurality of secured areas is required, such as opening of shelter facilities in case of war.

In some embodiments, the PACU may have a user interface that may permit an operator to input the second signal that was transmitted, for example, through a radio voice or video communication. The second signal transmitted to or inputted into the portable control unit may be encrypted/decrypted within said unit through a proper encryption/decryption protocol to generate the first signal.

It should be noted that the system of the invention is not limited to the manner in which the code is transmitted from the central system controller to the portable access control unit.

The portable control units serve as a link between the system controller and the one or more locks. Once a coded message is delivered to a lock, a registry for that lock in the controller may be adjusted according to the delivered code to reflect the current status of the lock. The link may be “closed”, by some embodiments of the invention, through a verification signal that a change has been made delivered by the lock that can be fed back to the controller by the portable control unit.

The central system controller can thereby keep track of operational parameters of each lock, without being on-line with the lock, thereby providing complete synchronization of the lock and the central system controller.

By one embodiment, upon initial initiation of the lock, the processor module may be pre-programmed with a plurality of pre-defined registries of permitted users that are permitted to operate the lock, and of non permitted users. To control operation of a lock, the PACU may transmit to the lock's receiver a first signal that consists of a permitted user code and a control code and only such permitted combination will activate the lock. This pre-programming also enables operational parameters changes of the lock upon transmission of the first coded signal by the portable control units, thereby enabling full control of the lock by the central system controller without the need for on-line communication with the lock.

Also provided by the invention is a lock, comprising an electronic control module, a receiving module for receiving a coded signal and a processor module for decoding the coded signal and controlling operation of the lock based thereon, the processor module storing one or more sets of lock-operating instructions functionalized by a system controller through a portable access control unit.

For increased safety and prevention of damage to the lock as a result of environmental conditions or vandalism acts, in an embodiment of the invention, said processor module and said receiving module are positioned at the inner side of a door onto which the lock is installed.

The invention further provides portable access control units operating in an access control system comprising one or more locks and a central system control, said unit being adapted for receiving a second coded signal from said central system controller and outputting a first coded signal based on said second signal for controlling operation of the one or more locks.

### BRIEF DESCRIPTION OF THE DRAWING

In order to better understand the subject matter that is disclosed herein and to exemplify how it may be carried out in practice, embodiments will now be described, by way of non-limiting example only, with reference to the figures, in which:

FIG. 1 is a schematic presentation of an exemplary system of the invention.

FIG. 2 shows a general design of a system of the invention for operating off-line locks.

FIG. 3 shows a general design of a system of the invention for emergency operation of on-line locks once on-line communication fails to establish.

### DETAILED DESCRIPTION OF EMBODIMENTS

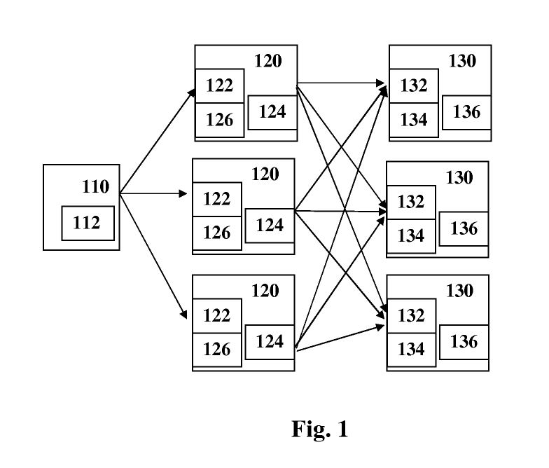

FIG. 1 is a schematic presentation of an exemplary access control system 100 of an embodiment of the invention. The system comprises a CSC 110, a plurality of PACUs 120 (three being schematically illustrated but the actual number may vary) and a plurality of locks 130 (three being schematically illustrated but the actual number may vary). The CSC 110 is equipped with communication module 112, which may be adapted for wired or wireless transmission/reception for communication with either or both of the PACUs (represented by arrows) and also the locks (not shown).

Each of the PACUs 120 comprises a receiver functionality 122 for receiving the second signal from the CSC 110, and transmission means 124 for transmitting the first signal one of the locks when in proximity thereto. The PACU may also comprise a decryption/encryption functionality 126 for decrypting the second signal and/or encrypting the first signal.

Each of the locks 130 comprises a receiver 132, which may, in an example, be adapted to receive the first signal in the form of knocks, and decryption functionality 134 for decrypting the first signal into a set of instructions for operating the control module 136 of the lock.

The CSC may communicate with each of PACUs 120 transmitting to them second signals for generation, within the PACUs, of the first signal to be delivered to each lock of the system. The second signal received by the PACU may generate a first signal operative for controlling a single lock or a group of locks.

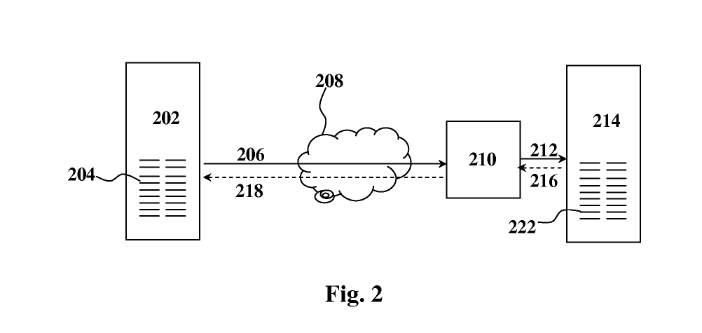

FIG. 2 illustrates a general design of a system of the invention in operation for off-line locks. A CSC 202, typically a server or a functionality distributed over more than one servers, comprises a database that holds registries 204 for a plurality of locks 214 (only one being shown for ease of illustration). For a lock initiation (namely configuring the lock so as to be part of the system) the CSC transmits a number of inactive registries 222 to each lock, which may, for example be in a wired communication mode.

In operation, e.g. following a user request, a second signal 206, which may be an encrypted code, is transmitted via network 208 (e.g. a cellular network) to the PACU 210. PACU 210 that includes functionalities of the kind illustrated in FIG. 1 generates a first signal 212, which may be in the form of a knock code of the kind described above (see WO 01/59288). This first signal 212 is then transmitted to the control module of a lock 214. If there is a match between the codes stored in registry 222 and that delivered by the PACU 210 and received in the lock 214, the lock is activated and may be unlocked or locked, as the case may be. The PACU may also deliver an authentication signal that may identify the PACU as being an authorized one. A combination of a PACU authenticity code and the specific, unique lock control code will then activate the lock.

The lock may be adapted to deliver a confirmation signal 216 which may be transmitted acoustically, electromagnetically or through a communication cable back to the PACU 210 and then a back-transmitted signal 218, transmitted to the CSC through network 208 provides an indication, recorded in registry 204, that a certain code is active.

The system of the invention may be configured such that each first signal 212 may be a one-time code, and after its use the lock's processor is rendered receptive to a different first signal. The CSC 202 may keep track of first signals used for controlling operation of a lock and issuing a subsequent second signal for inducing the PACU to output a different first coded signal to which a lock is receptive to. For each issuance of a new second signal, the registries 104 of the CSC update, preventing the re-issuance of an identical second signal. By this, the system allows for each lock or a group of locks to be operated by a unique, one-time code only.

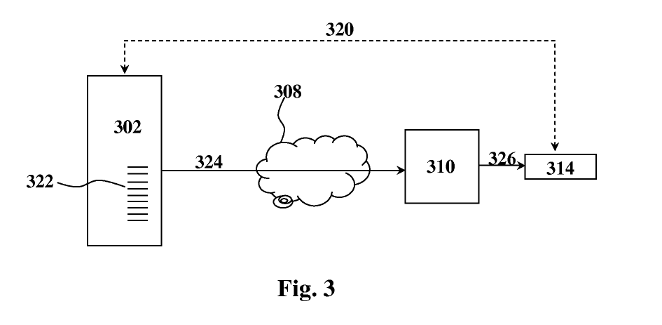

FIG. 3 shows the operation of an on-line system of the invention in emergency operation once on-line communication fails to establish between the CSC and the locks. During normal, on-line operation of the system, the locks 314 are in on-line wired or wireless communication link 320 with and controlled by the CSC 302. In emergency, at times when no such communication can be established between the locks and the CSC, registries 322 containing emergency codes are activated, transmitting a second activation code 324 from the CSC 302 to the PACU 310. The second activation code 324 may be encrypted by the PACU 310 to a first activation signal 326, which is transmitted to the lock 314. This first activation signal activates the lock, enabling managed control of the lock even though no on-line communication with the CSC exists.

1.-37. (canceled)

38. An access control system, comprising:
one or more locks, each comprises a receiver for receiving a first signal and a processor module for decoding the first signal and for controlling operation of the lock;
one or more portable access control units for delivering said first signal to one of said receiving modules when in proximity to a respective lock; and
a central system controller for delivering to said control unit at least one second signal; said first signal being generated by said portable access control unit based on said second signal.

39. The system according to claim 37, wherein the processor module of the lock is pre-programmed for recognition of the first signal with defined attributes and operating the lock based thereon, the first signal being decoded into instructions that define operational parameters of the lock processor module.

40. The system according to claim 37, wherein each first signal is a one-time code and after its use the lock's processor is rendered receptive to a different first signal and wherein the central system controller keeps track of first signals used for controlling operation of a lock and issuing a subsequent second signal for inducing the portable access control unit to output a defined first signal to which a lock is receptive to.

41. The system according to claim 37, wherein each lock or a group of locks is operated by a unique first signal.

42. The system according to claim 37, wherein said portable access control unit is adapted to output a unique, lock-specific first signal, corresponding to its geographical location.

43. The system according to claim 37, wherein one or both of the first or second signals are encrypted.

44. The system according to claim 37, wherein said central system controller transmits the second signal to said portable access control unit via wired or wireless communication.

45. The system according to claim 37, wherein said portable access control unit comprises a user interface for inputting the second signal.

46. The system according to claim 37, wherein the portable access control unit is an application, a functionality of a mobile communication device or a mobile communication device.

47. The system according to claim 37, wherein the first coded signal is transmitted from the portable access control unit to the electronic control module of the lock via RF communication, Bluetooth communication protocol, cellular communication, near field communication (NFC), an acoustic or mechanical signal in the form of a series of knocks.

48. The system according to claim 37, wherein the processor module of the lock comprises an emergency code, activated by receipt of an activation code from the portable access control unit.

49. The system according to claim 37, wherein said one or more locks are on-line locks.

50. The system according to claim 49, wherein the processor module of the lock comprises an emergency code operative once on-line communication fails to be established between the controller and the one or more locks, said emergency code being activated by receipt of an activation code from the portable access control unit.

51. A lock comprising a receiver for receiving a signal and a processor module for decoding the signal and controlling operation of the lock based thereon, the processor module storing one or more sets of lock-operating instructions functionalized by a system controller through a portable access control unit.

52. The lock according to claim 51, wherein said lock receiving module is adapted to receive a first signal from the portable access control unit via RF communication, Bluetooth communication protocol, cellular communication, near field communication (NFC), or an acoustic or mechanical signal in the form of a series of knocks.

53. The lock according to claim 51, wherein the processor module is pre-programmed for recognition of a first signal with defined attributes and operating the lock based thereon and adapted to decode the first signal into instructions that define operational parameters of the lock processor module.

54. The lock according to claim 51, being an on-line lock.

55. A portable access control unit operating in an access control system comprising one or more locks and a central system control, said unit being adapted for receiving a second signal from said central system controller and outputting a first signal based on said second signal for controlling operation of the one or more locks.

56. The portable access control unit according to claim 53, adapted for at least one of (i) encrypting the second signal into the first signal; (ii) communicating with the central system controller via wired or wireless communication; (iii) communicating with said one or more locks via wired or wireless communication; and (iv) transmitting said first signal as a series of knocks.

57. The portable access control unit according to claim 53, comprising a user interface for inputting the second signal and/or being an application or a functionality of a mobile communication device.
